(19) United States
(12) Patent Application Publication
(10) Pub. No.: US 2020/0043043 A1
(43) Pub. Date: Feb. 6, 2020

(54) SYSTEM AND METHOD OF PROMOTING ITEMS RELATED TO PROGRAMMING CONTENT

(71) Applicant: THE TALARIAST, INC., Thornhill (CA)

(72) Inventors: Anthony Luigi Cipolletta, Toronto (CA); Gabriella Raquelle Warger, Thornhill (CA)

(21) Appl. No.: 16/653,686

(22) Filed: Oct. 15, 2019

Related U.S. Application Data
(63) Continuation of application No. 14/309,148, filed on Jun. 19, 2014.
(60) Provisional application No. 61/837,507, filed on Jun. 20, 2013.

(51) Int. Cl. G06Q 30/02; H04N 21/482; H04N 21/4722; H04N 21/472; H04N 21/478

(52) U.S. Cl. CPC G06Q 30/0255; H04N 21/482; G06Q 30/0251; H04N 21/47202; H04N 21/47815; H04N 21/4722

(57) ABSTRACT

A system, apparatus, and method of promoting and discovering items related to programming content are disclosed. In one aspect, the system includes a first interface to a programming content supplier system, the first interface configured to receive data relating to any items available for promotion that are displayed in the programming content. The system includes a second interface to one or more promotion systems, wherein each promotion system includes item details on the items available for promotion, the second interface configured to receive, from a promotion system, item details. The system includes a promotion generator configured to match items displayed in the programming content with the items available for promotion from the promotion system. The system includes an interface generator configured to display items that are available for promotion to a user, and provide the user with an option to accept a promotion associated with the displayed items.

### CROSS-REFERENCE TO RELATED APPLICATIONS

This application is a continuation of U.S. patent application Ser. No. 14/309,148, filed Jun. 19, 2014 and titled “SYSTEM AND METHOD OF PROMOTING ITEMS RELATED TO PROGRAMMING CONTENT”, which claims priority from U.S. Provisional Patent Application No. 61/837,507, entitled “SYSTEM AND METHOD OF PURCHASING ENTERTAINMENT RELATED ITEMS” filed Jun. 20, 2013. The disclosures of each of these applications is incorporated by reference herein in its entirety for all purposes.

### BACKGROUND OF THE INVENTION

### Field

Embodiments relate to a system, apparatus, and method of promoting items related to programming content and, more specifically, to a system that connects users to a central programming promotion server that aggregates items related to a variety of programming content, designers of the items, and retail locations where the items can be promoted and/or purchased.

### Description of the Related Art

Programming content consistently relies on advertising as a source of income. Recently, viewers have been consuming programming content through new sources such as digital video recorders (DVRs) and online streaming sources. These new sources often contain fewer or no commercial advertisements or other promotional means, leading to a decline in traditional revenue streams such as advertising revenues.

One way in which content providers and producers have attempted to supplement such lost revenue is through product placement. This involves directly including products within the programming content such that the displayed items cannot be removed from the programming content.

### SUMMARY

In one innovative aspect, a system for promoting items displayed in programming content is provided. The system includes a first interface to a programming content supplier system, the first interface configured to receive, from the programming content supplier system, data relating to any items available for promotion that are displayed in the programming content. The system includes a second interface to one or more promotion systems, wherein each promotion system includes item details on the items available for promotion, the second interface configured to receive, from a promotion system, item details. The system also includes a promotion generator configured to match items displayed in the programming content with the items available for promotion from the promotion system. The system further includes an interface generator configured to display items that are available for promotion to a user, and provide the user with an option to accept a promotion associated with the displayed items. The system may include a trend analyzer.

In another innovative aspect, another system for promoting items displayed in programming content is provided. The system includes a first interface to a programming content supplier system, the first interface configured to receive, from the programming content supplier system, data relating to any items available for promotion that are displayed in the programming content. The system includes a second interface to one or more promotion systems, wherein each promotion system includes item details on the items available for promotion, the second interface configured to receive, from a promotion system, item details. The system also includes a promotion generator configured to match items displayed in the programming content with the items available for promotion from the promotion system. The system further includes a trend analyzer configured to generate trend indicators for items available. The system includes an interface generator configured to display trend information for items that are available for promotion to a user based on the trend indicators.

In either of the innovative aspects above, the interface generator may include images of performers, on-screen personnel, animation characters or musicians from the programming content, and may be configured to provide a link to items available for promotion that are used or worn by the performers, on-screen personnel, animation characters or musicians. The images may be displayed, in some implementations, on a scrolling window of images.

In either of the innovative aspects above, the interface generator may include images of sets from the programming content, and may be configured to provide a link to a good or a service shown in the set or on-screen for promotion.

In the described innovative aspects, data relating to an item available for promotion may include an item identifier, a designer identifier, a retailer or service provider identifier, a character identifier, and item details. Item details may include one or more of: a size, a color, a dimension, a scent, a cut, a material, a fashion style, a grooming technique, scope of service and a location for an associated item.

In the innovative aspects, the programming content can include an episode, a movie, a news program, informational programming, a music video, a commercial, a video game, a broadcast sporting event, live television programming, or a trailer.

In the innovative aspects described, the option to accept the promotion associated with items may include an aggregated option for accepting promotions associated with a plurality of items. The option to accept a promotion may include an option to purchase the item. If provided, a purchase option may include a purchase price indicating a price displayed to the user, the purchase price including a programming content provider amount identifying a first portion of the purchase price allocated to a producer or licensor of the programming content and a commission or fee identifying a second portion of the purchase price allocated to the system. A programming content provider may include one or more of a production studio, a broadcaster, or a content distributor.

In some implementations of the interface generator, the interface generator is configured to pseudo-randomly display items including one or more elements of the retrieved programming content or production information in the view.

The trend analyzer may be configured to obtain a log of activities of a plurality of users of the system for items, each activity having an activity type, assign a weight to each activity type, and identify a trending indicator for the items based on a count of each activity type and the weight of each activity type. The log may be obtained for items associated with the programming content, an actor, an episode, a scene, a set, a musician, a geographic location, or any combination thereof.

The activity type may be one of: a social media publication, a user comment, a view, a favorite, an addition to a wish-list, a purchase, an order, or a share.

In some implementations, the interface generator is configured to display user comments and associated items based on the trend indicators. The wish-list can include a set of items for promotion associated with an interest indicator received from a user.

The innovative systems may also include a personalization engine configured to receive, from the user, information identifying items of interest, and wherein the interface generator is configured to display trend information based on the items of interest.

In a further innovative aspect, a method of promoting items displayed in programming content is provided. The method includes receiving, from a programming content supplier system, data relating to any items available for promotion that are displayed in the programming content. The method includes receiving, from a promotion system, item details for the items available for promotion. The method includes matching, via a promotion generator, items displayed in the programming content with the items available for promotion from the promotion system. The method includes displaying, via an interface generator, item information for items that are available for promotion to a user. The method also includes providing the user with an option to accept a promotion associated with the displayed items.

A further innovative method of promoting items displayed in programming content is provided. The method includes receiving, from a programming content supplier system, data relating to any items available for promotion that are displayed in the programming content. The method includes receiving, from a promotion system, item details for the items available for promotion. The method further includes matching, via a promotion generator, items displayed in the programming content with the items available for promotion from the promotion system. The method also includes generating, via a trend analyzer, trend indicators for items available. The method also includes displaying, via an interface generator, trend information for items that are available for promotion to a user based on the trend indicators.

In a further innovative aspect, a computer readable medium having instruction stored thereon may be provided. The instructions, upon execution by a processor of an apparatus, may cause the apparatus to perform all or aspects of the promotional methods described herein.

In a further innovative aspect, a computer readable medium having instruction stored thereon may be provided. The instructions, upon execution by a processor of an apparatus, may cause the apparatus to perform all or aspects of the promotional methods described herein.

In yet another innovative aspect, an apparatus including a processor is provided. The processor is configured to perform all or aspects of the promotional methods described herein.

### BRIEF DESCRIPTION OF THE DRAWINGS

For a more complete understanding of the present disclosure, the objects and advantages thereof, reference is now made to the following description taken in connection with the accompanying drawings briefly described as follows.

FIG. 1 illustrates a block diagram of a system for promoting and discovering items related to programming content according to an embodiment.

FIG. 2 shows the programming promotion server of FIG. 1 in greater detail.

FIG. 3 shows a flow diagram for a method of promoting and discovering items related to programming content according to an embodiment.

FIG. 4 shows a flow diagram for generating a trending indicator based on user activities according to an embodiment.

FIG. 5 shows an example interface that may be presented to a user upon logging into the system

FIG. 6 shows an example interface for production content type of television shows.

FIG. 7 shows an example interface for an episode of a show.

FIG. 8 is an example interface of the character view for a show.

FIG. 9 is an example interface of the set view for a show.

FIG. 10 is an example interface of items available for promotion.

FIG. 11 is an example interface including trend information.

FIG. 12 is an example interface for wishlists.

### DETAILED DESCRIPTION

Programming content has increasingly come to rely on product placement within the content as an additional stream of revenue. Specifically, television programs, along with other types of programming or multimedia content, are now available to be viewed via digital video recorders (DVRs) or online, enabling viewers to consume the content without watching commercials. This has resulted in a decrease in the amount of promotional material that reaches the viewers of the content.

One method of increasing advertisement and promotional viewership is product placement. Product placement involves including product(s) within the programming content such that viewers necessarily see the products as part of the wardrobe, setting, location, etc. of the programming content. However, product placement is limited in that viewers may not be aware of the specific brands or manufactures of the products and therefore may not be able to locate information about the items such as the product identity, fashion styling, room staging, location information, artist, stylist, or total look (e.g., all items worn by a performer), included for promotion in a specific programming content. Accordingly, the viewer will be unable to purchase the product or engage with a promotion for the product, resulting in a lost potential sale or customer impression.

Consider a viewer who sees an item on her favorite TV show or movie and wants to buy it for herself. The item may be new designer shoes that a particular movie star wore in her latest movie or a vase that was visible on an apartment table. Consumers today are forced to guess the brand and availability of these items. Embodiments of the invention provide an official source system that connects items featured in production content to consumers. The system allows casual window shopping, inspirational browsing, targeted information research and item purchases. The described features further allow broadcasters, for example, to increase the value of programming content by including interactive promotions for items included in the programming content. Enhancing the interactivity of programming content is one way to improve viewer engagement.

Some embodiments include an official database and e-commerce site for content featured in entertainment content. Through interactions with programming content providers and designers/retailers, timely information on items featured on the entertainment medium are received and maintained. The described systems, methods, and devices allow product and service promotion directly to the consumer within their programming content environment. The described features also enable users to purchase these products by reference to the actual shows and programs that they are consuming.

Accordingly, embodiments include a system that links programming content providers, on-line and brick-and-mortar sales businesses, and entertainment information together into a cohesive systems for promoting and selling products that appear within programming content. The production companies know which clothing, accessories, and items will be in each scene of a program in advance of airing that scene to the public. This information can be available in a database that is accessible as part of the system. This allows viewers to come to the system through the network and browse for those authorized items that are available for promotion. On line sales businesses linked to the system can be sent the specific order to fulfill and ship directly to the customer. Alternatively, more popular items can be sent directly from a local warehouse to the viewer after receipt of the order.

The system may also be configured to monitor which items are the most popular and indicate that popularity to the viewers. Tracking popularity can be done by measuring sales of particular items from specific actors or shows. Popularity can also be measured by asking the on line purchasers to rate their purchase on a predetermined scale. The system can then monitor trends from the purchasing data or the rating data to generate popularity trends such as for each show, film, designer, apparel, footwear, character, furniture, set item, music video, Trunk, accessory, artist, pet, episode, scene, retailer, wishlist, product category, date, price, song, director, producer, video game, commercial, makeup, tattoo, hair care, body care, record label, distributor, studio, genre, upload date, performance, service, location, setting, scent, grooming technique, fashion style, broadcast sporting event, trailer, news program, informational, programming, billboard, contributor, advertisement, sponsored product, sponsored message, or advertiser.

In addition to serving the viewing public, the described features also provide valuable information processing regarding effective product placement. The described aspects, in some configurations, provide a new medium for businesses to link their products to consumers from all major forms of programming content (e.g., televisions, movies, music videos, video games, live broadcasts, etc.) all the while affixing information and promotional options for the consumer. Programming content providers, retailers, and designers are provided a promotional channel to gain exposure, awareness, control, and foster viewer engagement. The system and methods collect a variety of demographics related to the items and the programming content. This information is invaluable to programming content providers who can identify their existing audience and/or discover new audiences.

Embodiments of the invention include a database and communications system connecting the viewers of programming content with the content providers, retailers, and designers in order to facilitate the purchase of or the discovery of information related to the products displayed in the content. Embodiments act as an intermediary between viewers, content providers, retailers, and designers, enabling viewers to find the precise products used in the programming content and directing the viewers to locations where they can purchase the products or learn more about the product.

One non-limiting advantage to this system is that it simplifies the connection between viewers and displayed products, ensuring that viewers are able to purchase or learn more about the products shown within the programming content instead of a competing product. Viewers may be more likely to purchase or learn more about the promoted products due to the ease of locating the product and/or a corresponding online or brick and mortar retailer that carries the product.

Some aspects of the invention include systems for collecting information on the viewers that access the system. This information can include, for example, demographics based on registration data as well as information related to the viewer's use of the system such as page views, likes, favorites (e.g., identifying a show, character, episode, etc. as a favorite), shares, purchases, etc. This information can be used in developing viewer profiles which are valuable to stakeholders in the industry and can also be used to creating trending indicators which will be described in greater detail below.

One technical problem solved by the described technology is the lack of efficiency in aggregating products or items associated with programming content by a single user device. For example, in order to purchase items associated with programming content, the user device must first determine which items are associated with a given programming content via for example a first server. The user device must then locate and contact secondary servers to determine where each of the identified items is available for purchase and then individually purchase the items. This may require a relatively large amount of bandwidth since the user device must search available retailer servers in order to determine which items are associated with the programming content and where the items are available. In one aspect, the described technology also increases the speed of locating the items associated with the programming content and where the items can be purchased by maintaining a database. Further, since the user device does not have to search for retailers which offer the items, the bandwidth used by the user device can be reduced.

As used herein, the terms “product” and “item” refer, without limitation, to goods, services, or locations that may be promoted, advertised, placed within, or otherwise associated with programming content. For example, a product or item may refer to an article of clothing worn by an actor, furniture or accessories in the background, or a location at which a scene within programming content is filmed. In other examples, the product or item may refer to information describing aspects of the programming content such as how to achieve a certain look portrayed by an actor. The product or item may also refer to such goods, services, or locations merely referred to within or associated with the programming content.

To promote an item or a product, as used herein, refers to without limitation, displaying item or product information, purchasing, ordering a service, offering for sale, advertising, offering for lease, offering for rent, providing an incentive (e.g., coupon, free download), or otherwise calling attention to and/or providing a mechanism to obtain an item or a product included in programming content.

The term “programming content” as used in this disclosure refers without limitation to multimedia content, such as television programs, movies, commercials, music videos, news, video games, etc., as well as other forms of media, advertisements, or promotional material such as print media including newspapers, advertisements, billboards, etc. Programming content may also refer to live events such as concerts, conventions, panels, awards shows, etc.

The term “programming content provider” as used in this disclosure refers without limitation to program content creators, distributors, broadcasters, studios, and artists as well as other sources of programming content such as concert venues, video game pavilions, web-cams, Google glass, virtual reality devices (e.g. Oculus Rift), and the like. In some implementations, a retailer or a designer may be a programming content provider.

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the systems, apparatuses, and methods disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

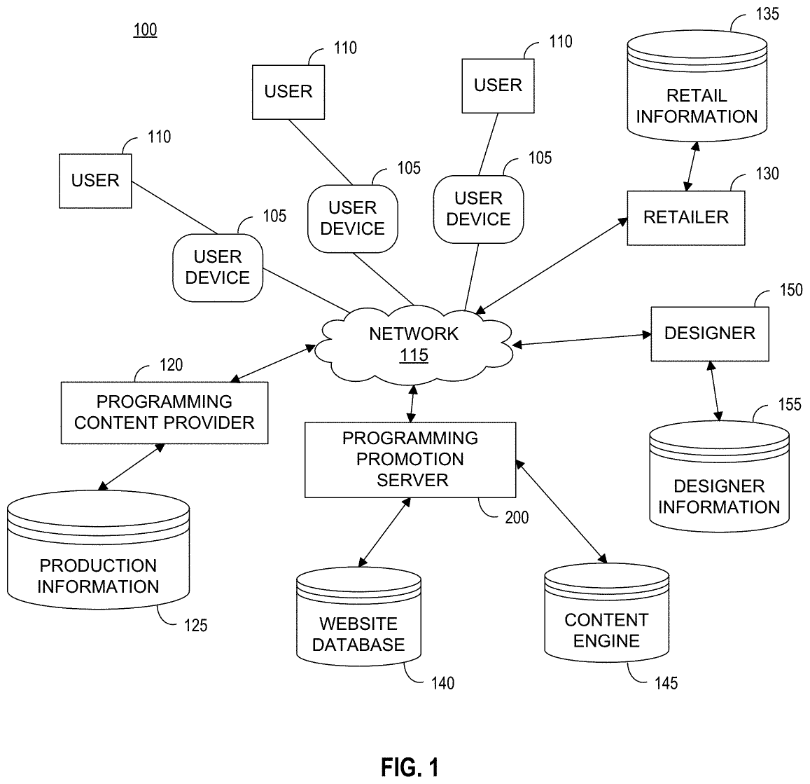

FIG. 1 illustrates a block diagram of a system for promoting and discovering items related to programming content according to an embodiment. The system 100 of FIG. 1 includes a plurality of user devices 105 connected to the network 115. The user devices can be any electronic user device 105 that can connect to the network. For example, the user device 105 may be a personal computer, a smartphone, a smartwatch, Google Glass, a tablet, a laptop, etc. A programming content provider 120, retailer 130, designer 150 and programming promotion server 200 are also each connected to the network 115. A plurality of users 110 are connected to the programming promotion server 200 via the network 115. The network 115 may include one or more cellular network, a data network, a local area network, a wide area network, a mesh network, the Internet, a public switched telephone network, a private network, a satellite network, or other standards based electronic or digital communication network. Communication via the network 115 may be accomplished via wired and/or wireless means. The communication may be protocol-based such as via HTTP, 802.11, and the like.

In the FIG. 1 embodiment, the programming content provider 120 is connected to a production information database 125. The production information database 125 stores product information related to the products or items included in individual programming content created by the programming content provider 120. In addition, the retailer 130 is connected to a retail information database 135. The retail information database 135 stores retail information related to the products available for promotion from the retailer 130. The retailer 130 may make the products available for sale online, in store (i.e. through a brick and mortar location), or both. When the products are services or locations, the retail information may indicate where the services or locations can be found so that the user 110 can find and/or order the services or locations. The retail information may further identify the specific service or location (e.g., braided eyebrows at a salon or a particular dining room or dish at a restaurant) within the content. Although not illustrated in FIG. 1, a plurality of programming content providers 120 and retailers 130 can be connected to the programming promotion server 200 via the network 115.

The system 100 also includes the designer 150 connected to a designer information database 155. The designer information database 155 contains information related to products or items designed by the designer 150 which may be accessed by the users 110 via the programming promotion server 200 as discussed below. The items for which information is stored in the designer information database 155 may be purchasable via the retailer 130 either online, in a brick and mortar store, or both. The designer 150 may also communicate with the retailer 130 via the network 115. For example, the designer 150 may authorize the retailer 130 to provide a particular item. This allows the designer 150 to control who can provide an item or information about an item.

The programming promotion server 200 is connected to each of the user devices 105, the programming content provider 120, the designer 150, and the retailer 130 via the network 115. The programming promotion server 200 is further connected to a website database 140 and a content engine 145. The website database 140 stores information used by the programming promotion server 200 in generating a view or interface to be displayed on one of the user devices 105. The user 110 can find and select items, services, fashion styles/looks, products, or locations they wish to purchase, order, or obtain information about by navigating through a plurality of views generated by the programming promotion server 200. This will be described in greater detail below. In contrast to the embodiment illustrated in FIG. 1, each of the website database 140 and content engine 145 can be implemented within memory in the programming promotion server 200.

The views displayed on the user devices 105 are populated by information stored in the content engine 145. The content engine 145 stores information related to the items having promotional options available for acceptance by the users 110. This information can be entered into the content engine 145 by the programming promotion server 200. In the embodiment of FIG. 1, the programming promotion server 200 receives the item and location information from the programming content provider 120 and the promotion information from the retailer 130 and/or the designer 150. The content engine 145 stores item information and retail information in a hierarchy so that the programming promotion server 200 can populate the views that are sent to the user devices 105 with the item information and retail/designer information related to queries received from the respective user devices 105.

The programming promotion server 200 also processes the product information and the retail information prior to storing the information in the content engine 145. Specifically, the programming promotion server 200 matches each of the items, services, fashion styles/looks, locations, or products in the product information with the retailers or designers that are promoting the items, services, fashion styles/looks, or products based on the promotion information. Accordingly, the information stored in the content engine 145 may include retail locations (online or brick and mortar) where each of the items, services, fashion styles/looks, or products is available in addition to the production information such as the specific programming content, scene, actors, etc. featuring the items, services, fashion styles/looks, or products.

In another embodiment, the product and retail information are not received from the programming content provider 120 and the retailer 130 over the network 115. In this embodiment, the product and promotion information are manually entered into the content engine 145 via an input interface (not shown). However, this disclosure is not limited to the above described methods of populating the information in the content engine 145 and other methods of transmitting the product and promotion information to the content engine 145 can be used without departing from the teachings of this disclosure.

Returning to the embodiment of FIG. 1, each product identified by the product information stored in the content engine 145 is identified by an item identifier. The item identifier is associated with a programming content identifier. The programming content identifier identifies which programming content the product was featured in and each item identifier may be associated with multiple programming content identifiers when the product is featured in more than one programming content. Depending on the type of the associated programming content and the type of the product, the item identifier may be further associated with a character identifier, a set identifier, a season identifier, an episode identifier, a scene identifier, etc.

Each product may be additionally associated with a retailer identifier and/or designer identifier indicating where the product is available and item details. The item details include information relating to different attributes of the item available to sale, such as, the color, dimensions, scent, cut, material, service provider (e.g., stylist, tattoo artist, make-up artist, hair dresser), and location for the item. When the product is not available for sale, the product may instead be associated with information relating to the product such as its location, a brick and mortar retailer that the product can be purchased from, the method of obtaining the product or fashion look, a back-ordering process, or a pre-ordering process.

However, the product information stored in the content engine 145 is not limited to the above described structure and can be stored within the content engine 145 is any way that enables the products to be sorted based on the programming content or any other identifying criteria.

The item identifier further includes a provider or retailer identifier indicating where the product can be purchased from or where the service or location is located. In the FIG. 1 embodiment, the product information including the item identifier is received at the programming promotion server 200 from the programming content provider 120 for storage in the content engine 145. The provider or retailer identifier may also be received from the programming content provider 120 or may be received from the retailer 130.

In addition to the above described identifiers, the product information stored in the content engine 415 may also include images of each of the products. When the product is an article of clothing or an accessory, the images may be stills from the programming content where the on-screen personalities (e.g., actors, artists, animals, animated characters) are wearing the items. The images can be sent to the user devices 105 so that the users 110 can preview the items. When the product is furniture or another background product, the images may be stills from the programming content or other images showing the product.

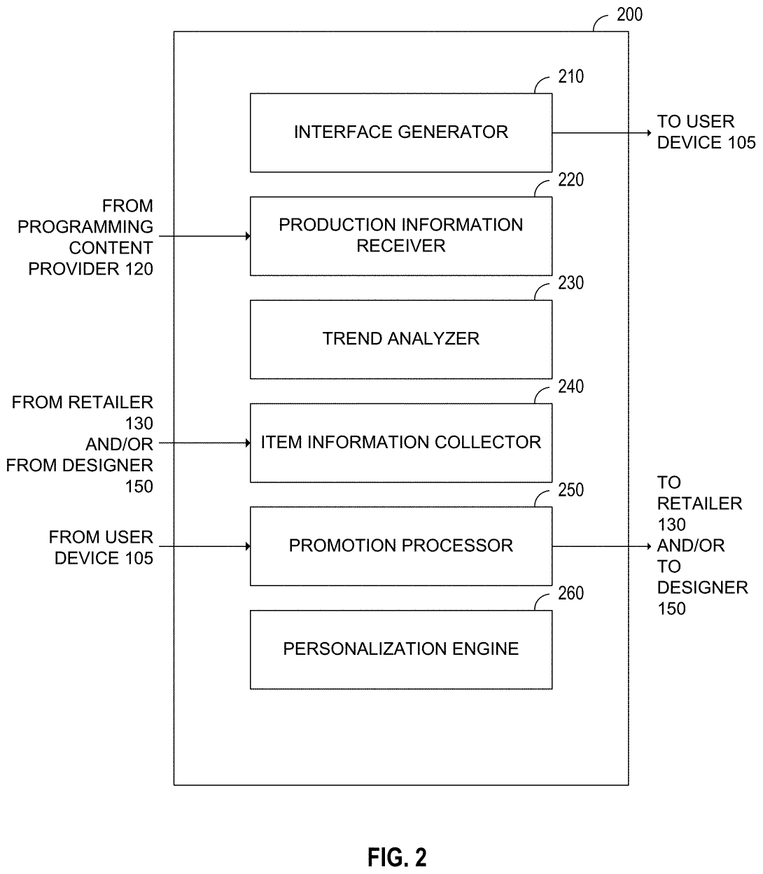

FIG. 2 shows the programming promotion server of FIG. 1 in greater detail. With reference to FIG. 2, the programming promotion server 200 includes an interface generator 210, a production information receiver 220, a trend analyzer 230, an item information collector 240, a promotion processor 250, and a personalization engine 260. In certain implementations, the programming promotion server 200 may include other interface or processing modules or a subset of the interface and processing modules illustrated in FIG. 2. The programming promotion server 200 also includes interfaces (not shown) for connection to the network 115, the website database 120, and the content engine 145.

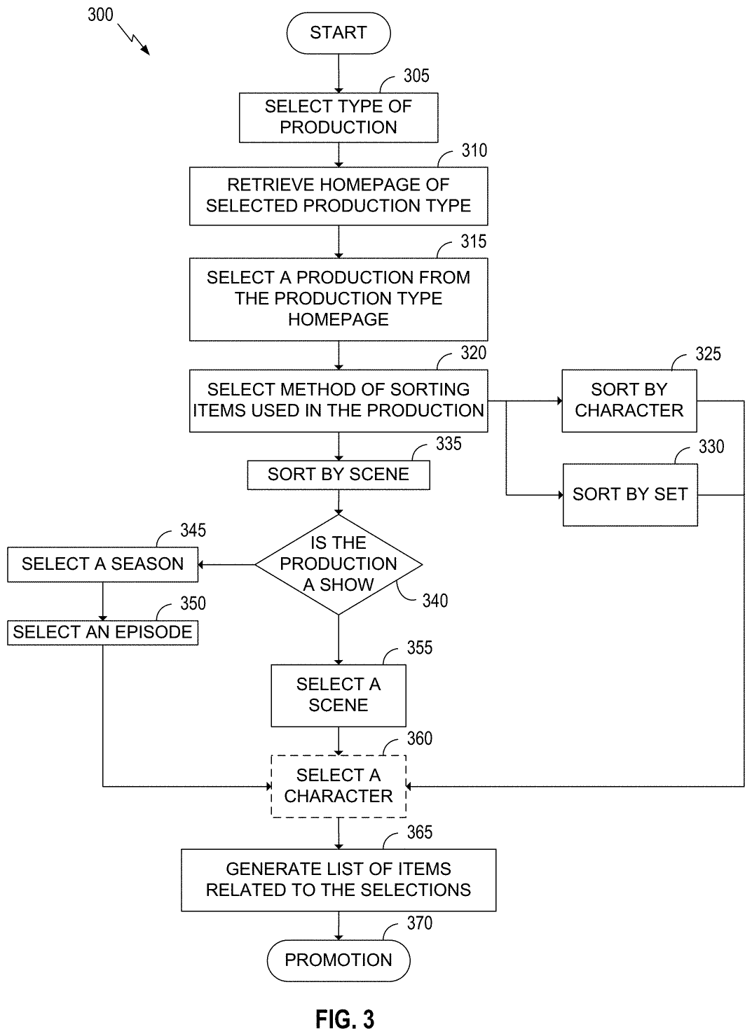

The interface generator 210 generates the user interfaces that are sent to the user devices 105. Each of the user interfaces provides a plurality of options to the user 110 for sorting the products based on user selected criteria. For example, the products can be sorted by production format (i.e. type of programming content), programming content, character, set, scene, etc. One embodiment illustrating the sorting of products for purchase by a user 110 is shown in FIG. 3 and will be described in detail below.

The production information receiver 220 is an interface which receives the product information from the programming content provider 120. The product information is optionally processed and then stored in the content engine 145.

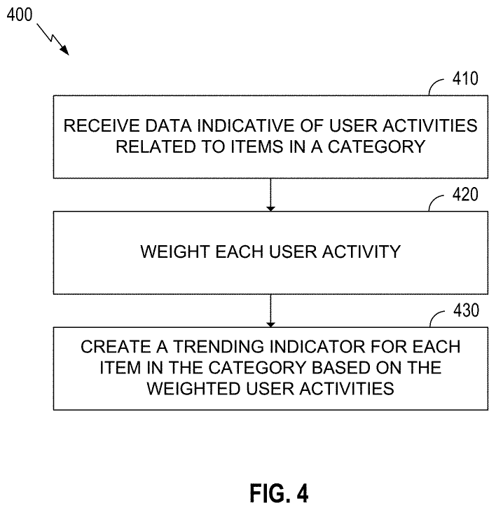

The trend analyzer 230 generates a trending indicator for each category of products based on user activity with the programming promotion server 200. In one embodiment, different user activities are weighted to generate the trending indicator as shown in FIG. 4 and described in detail below.

The item information collector 240 is an interface which receives the retail and/or designer information from the retailer 130 and/or designer 150. The retail information is processed and associated with the corresponding product information such that information regarding where the products can be purchased (either online or through a brick and mortar location) or where the services or locations are located or other information associated with the product is relayed to the user 110 via the user device 105. Similarly, the designer information is processed and associated with the corresponding product information such that information about the designer is relayed to the user 110 via the user device 105 when requested.

The promotion processor 250 receives purchasing information from the user devices 105 and facilitates the purchase of the indicated products. The purchase processor 250 can automatically complete the purchase of a product or group of products from one or a plurality of retailers 130 for the user 110. After completion of the purchase, the purchase processor 250 notifies the user 110 of the purchase.

The personalization engine 260 collects information for each user 110 about that user's 110 personal preferences. The personalization engine 260 can receive, from the user 110, information identifying items or categories of interest. The personalization engine 260 displays, or causes the interface generator 210 to display, trending indicators based on the identified items or categories of interest. For example, the personalization engine 260 can also receive information identifying actors, characters, or sets of interest and the displayed trending indicators includes trending indicators based on the identified actors or characters.

The personalization engine 260 may also be used to select specific information from the content engine 145 when populating an interface to be displayed to the user by the interface generator 210. For example, if the user has shown an interest in a specific programming content or actor, the personalization engine 260 may be more likely to select items or trending indicators closely related to that programming content or actor. The personalization engine 260 may also select products or items based on other users 110 that are associated with the user 110 such as through friending, following or other associations between users.

FIG. 3 is a flow diagram for an example of a method of promoting and discovering items related to programming content. The method 300 may be implemented between one of the user devices 105 and the programming promotion server 200 as shown in FIGS. 1 and 2. In the embodiment of FIG. 2, the method is initiated by the interface generator 210 of the programming promotion server 200.

At step 305, the user 110 selects a production type. The production type selected by the user 110 is the type of the programming content that the user desires to view. In some implementations, the user 110 is prompted to select the production type by receiving a prompt from the programming promotion server 200 at the user device 105. The user 110 then selects the production type (for example, a show, movie, music video, commercial, trailer, etc.) from the prompt and the user device 105 returns the selected production type to the programming promotion server 200.

As step 310, the programming promotion server 200 retrieves the homepage for the selected production type. This may involve requesting the homepage from the website database 140 and populating the homepage with information from the content engine 145. The homepage is then displayed on the user device 110 and includes a plurality of productions or programming content of the selected production type.

At step 315, the user 110 selects one of the productions from the homepage. At step 320, the user 110 is then prompted by the programming promotion server 200 to select a method of sorting products within the production. The available methods for sorting may be determined based on the type of the production. Accordingly, for certain production types, step 320 may be performed automatically by the programming promotion server 200. Three different sorting methods are shown in FIG. 3, however, many other methods of sorting the products based on associations between the products and various aspect of the production can be implemented without departing from the teachings of this disclosure.

At step 325, the products are sorted by character based on the selected sorting method selected in step 320. Alternately, at step 330, the products are sorted by set. Each of steps 325 and 320 continues at optional step 360, described below.

At step 335, the products are sorted by scene based on the user's 110 selected sorting method from step 320. The programming promotion server 200 then determines, at step 340, whether the selected production is a show. If the production is a show, the method continues at step 345, where the user 110 selects a season, and step 350, where the user selects an episode. The default choice in each of steps 345 and 350 may be the most recently aired season and episode in the show.

After step 350 or if the production is determined to not be a show in step 340, the user is prompted to select a scene in step 355. After each of steps 355, 325, and 330, the method may optionally include step 360. At step 360, the user 110 selects a character. In some implementations, the user 110 may instead select an actor instead of a character. Prior to making a selection, the characters or actors can be displayed by the user device 105 as a scrolling window of images.

Next, at step 365, the programming promotion server 200 generates a list of all of the products associated with the selections in the above steps 305-360. For example, if the user 110 had selected a character in a specific scene for a show production, the generated list would include the clothing and accessory items worn by that character in the specific scene. In some implementations, the items in the list are displayed by the user device 105 in a pseudo-random order.

Finally, at step 370, the user 110 is given the option to accept the promotion(s) for all of or any subset of the products in the list generated in step 365. Examples of accepting the promotion may include purchasing or ordering one or more items, viewing information about the one or more items, and obtaining a coupon or other incentive for the one or more items. When the user 110 decides to accept a promotion, the process may then be continued by a promotion processor, such as the promotion processor 250 shown in FIG. 2, to complete the transaction.

Based on the selection of which items to purchase from the generated list, the programming promotion server 200 further displays a price to the user 110 indicating the purchase amount. In some implementations, two portions are divided from the purchase amount and are respectively distributed to the producer of the programming content and as a commission for the programming promotion server 200. Further portions may also be divided from the purchase amount to be distributed to the retailer 130 and/or the designer 150. In other implementations, the programming promotion server 200 provides a link to an online retailer that sells the items to the user device 105.

As described in the embodiment of FIG. 3, users 110 of the system 100 are able to search for any products used in the production of their choice. Since the product, service, or location promoted within the production are retrieved from the programming content provider 120 and stored in the content engine 145, the user 110 can be confident that the items being purchased are those that were used in producing the programming content. Further, the user 110 may be able to purchase an entire set of items associated with certain aspects of the production. For example, by selecting a character, the user 110 can purchase the entire outfit worn by the character plus reserve a table at a restaurant the character wearing that outfit dined at in a given scene. Accordingly, user's 110 can find and purchase entire sets of items without the need of finding each individual item in different retailers or departments of a retailer.

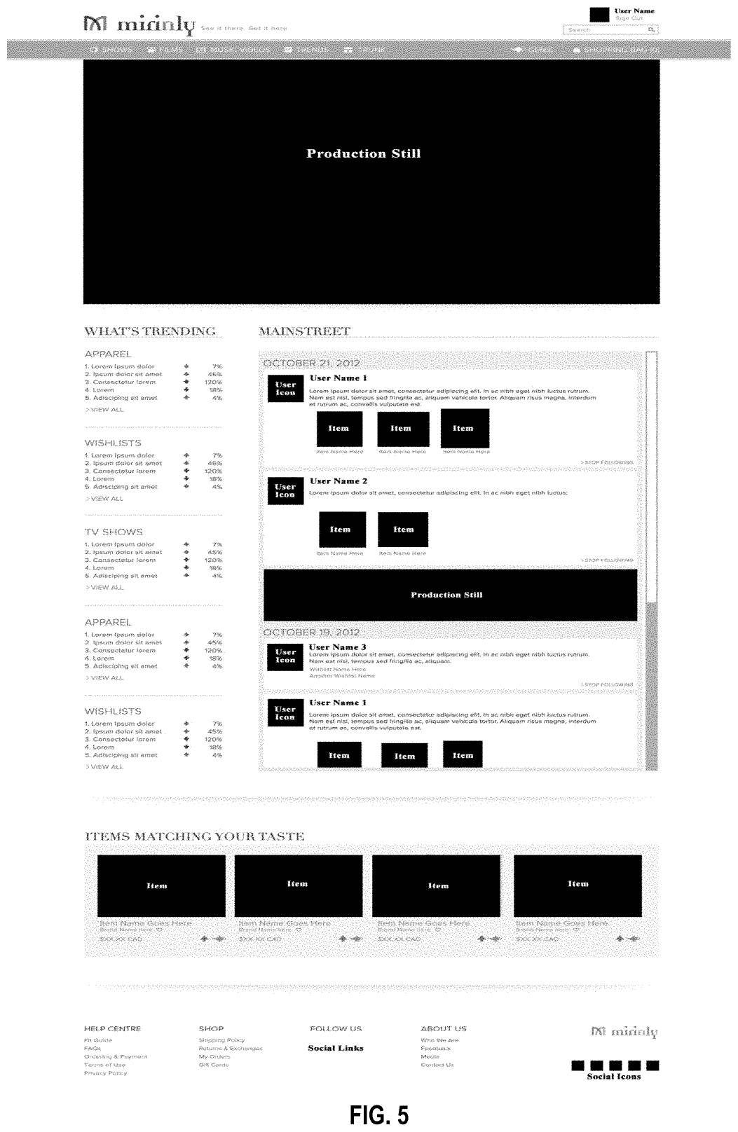

Example interfaces generated by the interface generator 210 for display on the user devices 110 are shown and described in further detail with reference to FIGS. 5-12. These example interfaces may be generated at various points in the method of FIG. 3.

Another embodiment is a method of obtaining information of items related to programming content. In this embodiment, the designers may not wish for their products to be available in an online store. Alternately, the items may be services or locations which cannot be sold through online retailers. Thus, in this embodiment, instead of giving the user the option to purchase the list of items as is step 370 of FIG. 3, information relating to the list of items is displayed to the user 110 via the user device 105. Accordingly, the user can select one or more items from the list and obtain information related to those items. For example, the user may obtain information about where the location of a shop shown in a film is or the location of a service vendor used in providing services for the programming content. In another example, the information displayed to the user teaches the user how to obtain a fashion look associated with a character in the programming content.

When the item displayed to the user 110 is a location or service, the user device 105 may be further configured to assist the user 110 in finding the location or service via geo-tagging. Geo-tagging refers to a method of displaying or guiding the user 110 to a given location. Accordingly, in one example, the user device 105 displays a map showing the user 110 directions to the location associated with the selected items. In another example, the user device 105 will notify the user when an item wishlisted and/or favorited is nearby or available.

Another aspect of the disclosure is the tracking of user activity within the system. The tracked user activity can be used to generate trending indicators or can be aggregated to generate information about consumer psychographics. FIG. 4 is an embodiment illustrating a method for creating trending indicators based on user activity.

The method 400 can be performed by the trend analyzer 230 of the programming promotion server 200. The method 400 of FIG. 4 begins at step 410 where the trend analyzer 230 receives data indicative of a plurality of user activities related the items in a category. Each category refers to a collection of purchasable or selectable items or products. Example categories include apparel, accessories, characters, set items, episodes, or any other category of associated items. The user activities may include, for example, page views, likes, favorites, shares, and/or purchases.

At step 420, each user activity is weighted for each item based on the desired impact of the user activity on the trending indicator. In some implementations, the purchases user activity is weighted heavier than the other user activities such that purchases impact the trending indicator greater than the other user activities.

At step 430, the trending indicator for each item in the category is created based on a count of each user activity and the weight of each user activity. Steps 410-430 may be repeated for each category to be displayed in a given view.

The trend indicators can be generated for each view sent to the user devices 105 and are based on the content of the view sent to the user device 105. For example, when a user has selected a production from the production type homepage in step 315 (see FIG. 3), the trend indicators included in the next view sent to the user device 105 may include trends of categories or items related to the selected production. It may be desirable, in some implementations, to also include a universal trend indicator identifying a system-wide trend for an item. Further, if the user has not yet made a selection, the trend indicators included in the initial view reflect categories from the entire programming promotion server 200.

One embodiment of the disclosure is as described below. The trends used in this embodiment are the easiest way for users 110 to view the general direction in which the popularity for content featured within the system 100 is developing and/or changing. An item's trend weight is based on its individual number of likes, views, shares, comments, favorites, orders, and purchases off the website. Trends are divided into two subcategories: universal trends and local trends. “Universal” trends showcase the overall system 100 facts and “local” will be trends specific to the page the user 110 is currently viewing (including, without limitation, a specific show, character, designer, wish list, product category, artist, record label, studio/production label, programming content provider, distributor, genre, and upload date). Trends are shown on every page and are updated in real time (green upward arrow indicates that the item's popularity has risen, blue hyphen indicates neutrality [remains stagnant], and a red downward arrow indicates popularity has declined). Trends display “universal” trends made up of several categories such as: a) a comparison of how popular the items of the user's 110 wish list contrasts to the universal trends, b) wish list, c) shows, d) films, e) designers, f) apparel, g) footwear, h) characters, i) set items, j) music videos, and k) Trunk (e.g., a collection of items available for promotion). Trends also displays “local” trends. For example, a user 110 can view all of the trends within a single programming content or all of the trends within any other page the user 110 is currently viewing. Trends can be viewed by text or image.

Another aspect of this embodiment is the sorting of programming content by show. This section features the user's 110 favorite shows, sponsored shows, recommended shows based on user's 110 activity, new episodes of user's 110 favorite shows, and all shows from A to Z. The subsections include episodes which are shown by the most recently broadcasted; the user 110 has an option to view episodes in other seasons as well. A still of scenes is featured in order of sequence. The user 110 selects a scene, where a picture of it is shown with a carousel of characters in the scene underneath the still. Upon selecting the character's image, the other characters' images fade and the items the chosen character is associated with expand underneath the carousel.

Another subsection is the characters subsection in which the characters of each show are featured in a carousel, with the following sections: Notable (e.g., signature looks) and All Looks (e.g. from most recent scene, most recent season). An image of the character will be adjacent to the items associated with that image. A further subsection is the set items subsection where set items used throughout the show are featured, which are organized such as by season, category (e.g., dining room, kitchen), setting (e.g., physical location, location type such as apartment, house, or museum), or layout (e.g., blueprints or virtual walk-throughs).

The described features may provide the above mentioned advantages to a variety of parties. For example, users (e.g., the viewing public) may access the system. Culture has placed celebrities and TV personalities as the benchmark of consumer goods. Users want to emulate these figures and want to have what they have. Currently, users have to scour through many sources to discover and/or purchase the items featured in entertainment. Often, they are unable to find the “true” item and at best, find an item that is similar. Consequently, this speculation leaves them unsatisfied. To meet this need, the aspects described provide speed and legitimacy by enabling users to find and/or purchase the official desired item in an efficient manner.

Programming content providers may be another group to benefit from the aspects described. With the increased use of viewing entertainment on DVRs and online, less individuals watch content, and therefore commercials, during the real-time broadcasts. Therefore, programming content providers have less leverage against advertisers and other promotional service providers. The described features provide a controlled method to provide product promotions and collect meaningful analytics on the value of certain placements. For example, it can be quantified using the described systems and methods how valuable it is to have a specific character wearing a designer's shirt in an episode. Furthermore, the system can act as an extension of the programming content provider's public relations and marketing departments, providing authorized and accurate information regarding the production content. This can, in some instances, revive newfound interest in programming content.

Designers and retailers may also benefit from the aspects described. The system can generate user demand for the designers' items on viewed content because of the emotional connection they have already established with said content and the character(s) in it. This can increase the designer's renown and boost sales for the designer and retailers carrying their products. The retailers, be they on-line or offline, can increase the interest in products offered through their stores. For example, the systems may include retailer information (e.g., web-site or physical store location) to users to facilitate finding a source for the product they already covet due to, for example, its association with the scene it is promoted in. Furthermore, thanks in part to the analytics collected by the system, proven metrics regarding expenses allocated on product placement may be obtained.

FIGS. 5-12 show example interfaces which may be generated by the systems and methods described for promoting items in production content. The interfaces shown in FIGS. 5-12 may be provided for presentation on a user device 105. The interfaces may include a control (e.g., link) to allow navigation from one interface to the next.

FIG. 5 shows an example interface that may be presented to a user upon logging into the system. The interface may include one or more production still images or videos. The interface shown in FIG. 5 also includes trending information for apparel, wislists, and TV shows. The interface further includes a section entitled “Mainstreet” which includes user comments, updates on the user's favorites and friend activity, sponsored messages, and associated items. The information included on Mainstreet may be selected based on local and/or universal trend indicators. The interface in FIG. 5 also includes a gallery of items that match the user's tastes. The matching may include comparing items or production content the user has expressed interest in (e.g., leather shoes, iguanas, soccer, particular characters) with items other users with similar interests have highlighted. To enhance the user engagement, each interface may include social media icons or other publication icons to allow the publishing of at least a portion of the interface to another platform. In FIG. 5 and the interfaces that follow, when an item is shown, the item may be associated with a control that, upon activation, presents item details and promotion associated with the item.

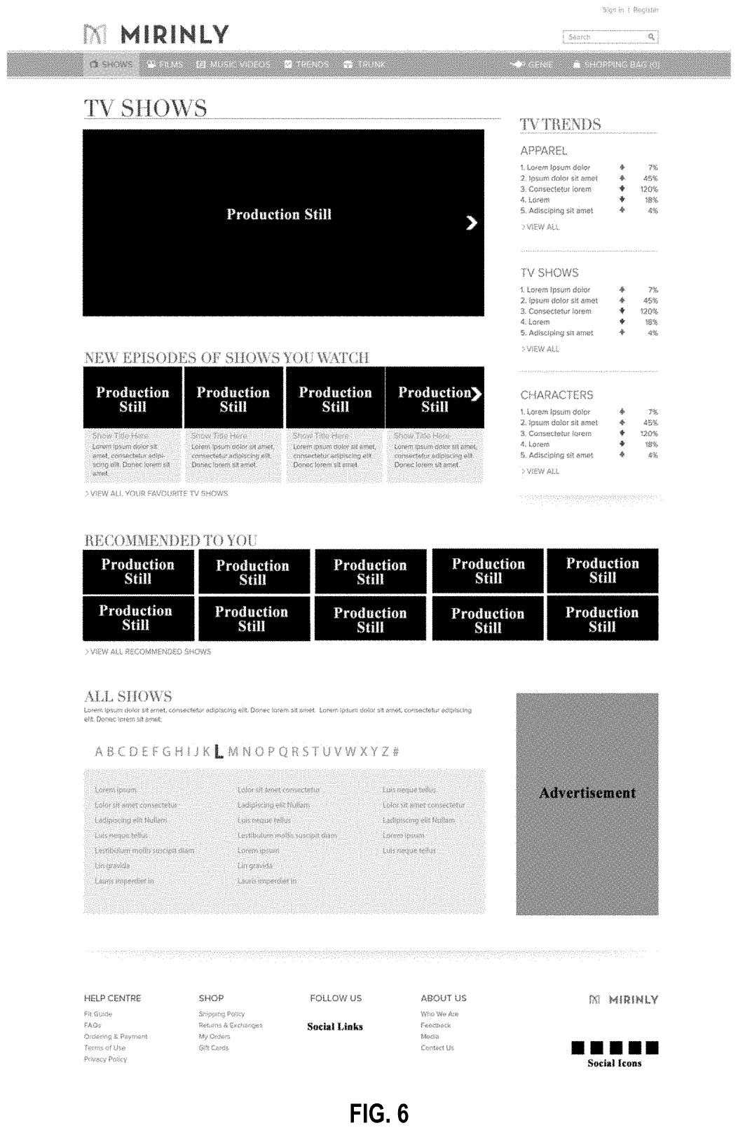

The interfaces may be presented in a hierarchical manner. The hierarchy may be organized based on production content type. FIG. 6 shows an example interface for production content type of television shows. The interface includes TV trends which narrow the trend indicators to those related to television. The interface includes stills from television shows to facilitate easy browsing and identification of a show and episode of interest. The interface in FIG. 6 also includes a show recommendation control including one or more television shows that may interest the user. A directory of all shows may also be included in some implementations.

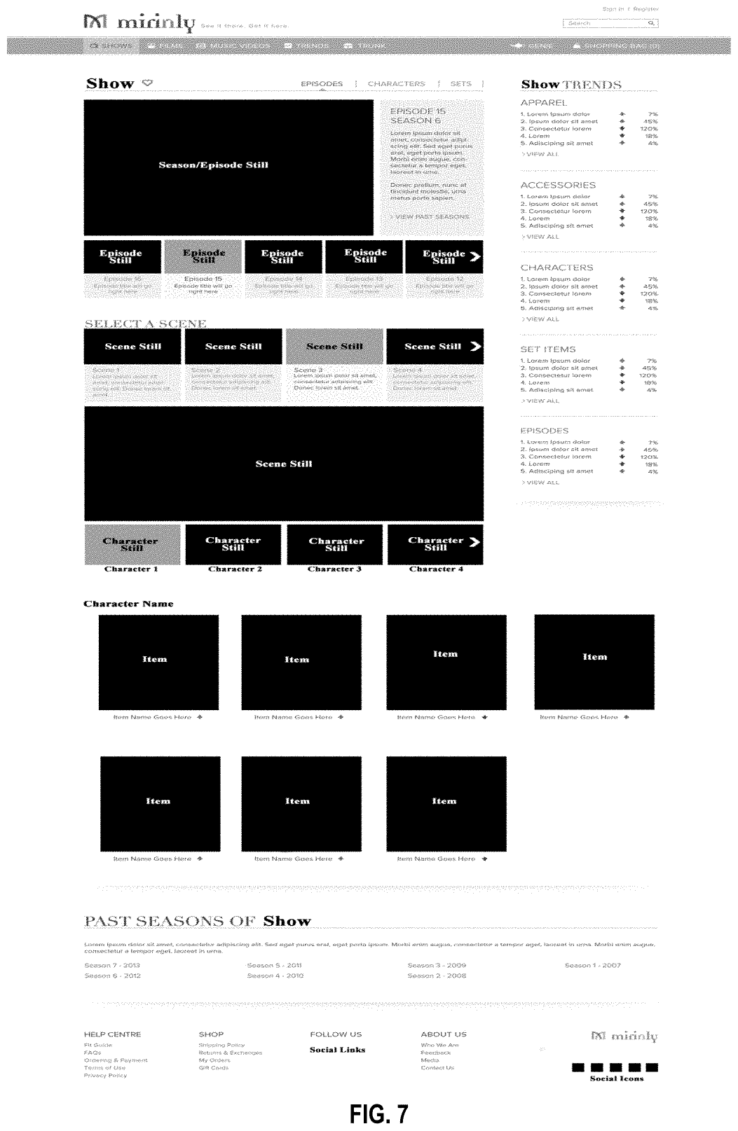

A user may select a show. FIG. 7 shows an example interface for an episode of a show. The show information may be further explored based on episode, character, or set. Within an episode of a television show, there may be one or more scenes. The interface shown in FIG. 7 provides an episode selector. Once an episode is selected, such as episode 15 season 6 in the example shown, a scene selector may also be provided. Upon receipt of a scene the production information for the scene is presented to the user. This may include characters in the scene. A character may be selected (e.g., character 1 in the example interface), and the items associated with the character presented. As shown in FIG. 7, there are seven items presented for the selected character. The show interface may include links to past seasons of the show which, upon activation, present a show interface similar to the one shown in FIG. 7, but featuring the episodes, scenes, and characters from the selected season. The interface includes show trends which narrow the trend indicators to those related to the selected show and further to trend indicators related to the user's other selections such as the selected scene or season. The interface may further include a control that, when activated, transmits a message to the server indicating the show is a “favorite.” For example, in FIG. 7, at the head of the page, next to the show title, a heart icon is provided. The heart icon may be clicked to indicate the show as a user favorite. Characters, episodes, artists, retailers, designers, stylists, sets, and locations are a few examples of information managed by the system that may be identified as a favorite.

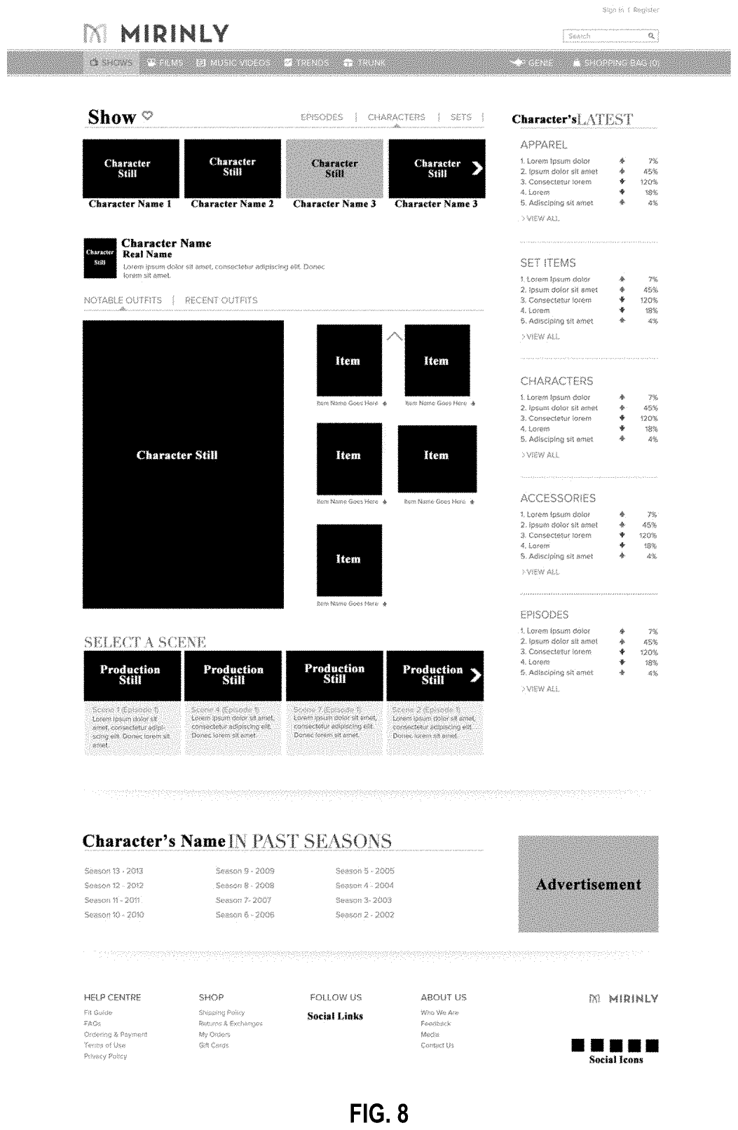

FIG. 8 is an example interface of the character view for a show. Whereas FIG. 7 provided a view of the show by episode, FIG. 8 provides a view of the show by a character. The interface shown in FIG. 8 includes character trends which narrow the trend indicators to those related to the selected character. The interface also includes stills of the character to display the “looks” associated with the character. As shown in FIG. 8, five items are associated with the selected character. As discussed above, the items may include an item worn, a fashion styling, body art, or other aspect which may be promoted to viewers. Character looks may be explored based on “notable outfits” which are the “signature” look for a character. In the implementation shown in FIG. 8, the character look can also be explored based on recent outfits which provides outfits worn in a recently presented episode. The character interface may include links to past seasons of the show which, upon activation, present a character interface similar to the one shown in FIG. 8, but featuring the character's looks from the selected season.

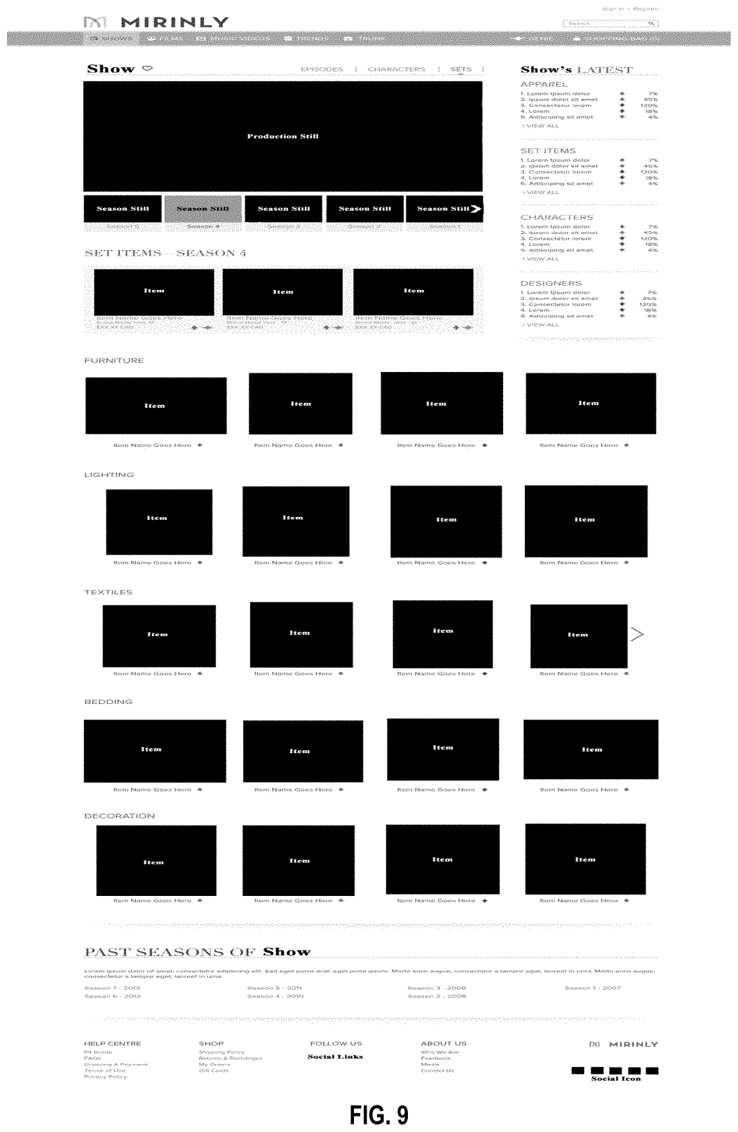

FIG. 9 is an example interface of the set view for a show. The interface shown in FIG. 9 includes character trends which narrow the trend indicators to those related to the selected show. It will be noted that the categories of trend information is adjusted so as to relate to the view for the interface. A season selector may be included in the interface. As shown in FIG. 9, season 4 is selected. The set items for season 4 are provided. Items may be further divided by categories such as furniture, lighting, textiles, bedding, or decoration. The items may also include, as discussed above, services or menu items for the set/location. In some implementations, the production information provided for the programming content may include blueprints for sets or locations. In such implementations, the interface may present items over areas of a blueprint or otherwise organize items such that the location of the item is associated with a location on the blueprint corresponding, at least approximately, to where the item is found in the programming content. The blueprint may, in some implementations, be interactive such that clicking on an area of the blueprint updates the set view interface to display the items in the activated area. In some implementations, the interface may also organize the items by the settings associated with the programming content. In these implementations, the interface may present each of the settings associated with the programming content for selection by the user, and after selection, the interface is updated with the items associated with the selected setting. A past season control element may also be provided similar to that described in reference to FIGS. 7 and 8.

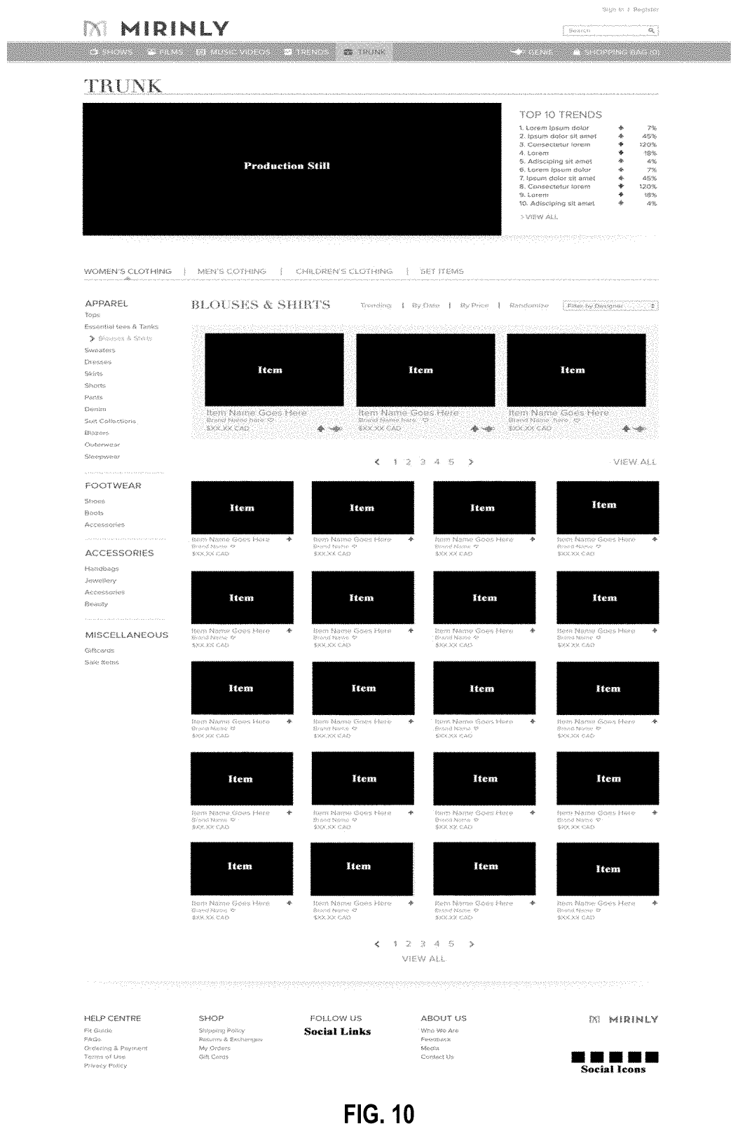

FIG. 10 is an example interface of items available for promotion. In some implementations, this directory of items may be referred to as “Trunk”. This interface provides a catalogue of all items for promotion via the system. The interface may be subdivided to assist in finding items of interest. For example, items may be subdivided into men, women, children, zeitgeist (i.e. the top trends), pets, and set items. A user can filter the items by trends, date, price, designer, and randomizer (e.g., generates items for users arbitrarily). The item information within the catalogue format may include item name, brand name, price, add to wishlist, add designer to favorites, and trending status. Some interfaces may include sponsored items which may not be featured in a show but may be of interest to viewers of the show. A quick-view option may be included such that when the user toggles the cursor over an image of the item, a “quick-view” window will provide a sub-interface including information associated with the item. The information may include one or more of a brief description of the product, brand name, share icons for publishing the item to another platform, add to wishlist, add designer to favorite, trending status, and view item on product page. The product page may include trending status, color options, size options, quantity, price, add to cart, add to wishlist, product description, where the item appears, which artists and/or characters, for example, the item is associated with, shipping and return policy, and share icons; related apparel and complete the look are displayed underneath.

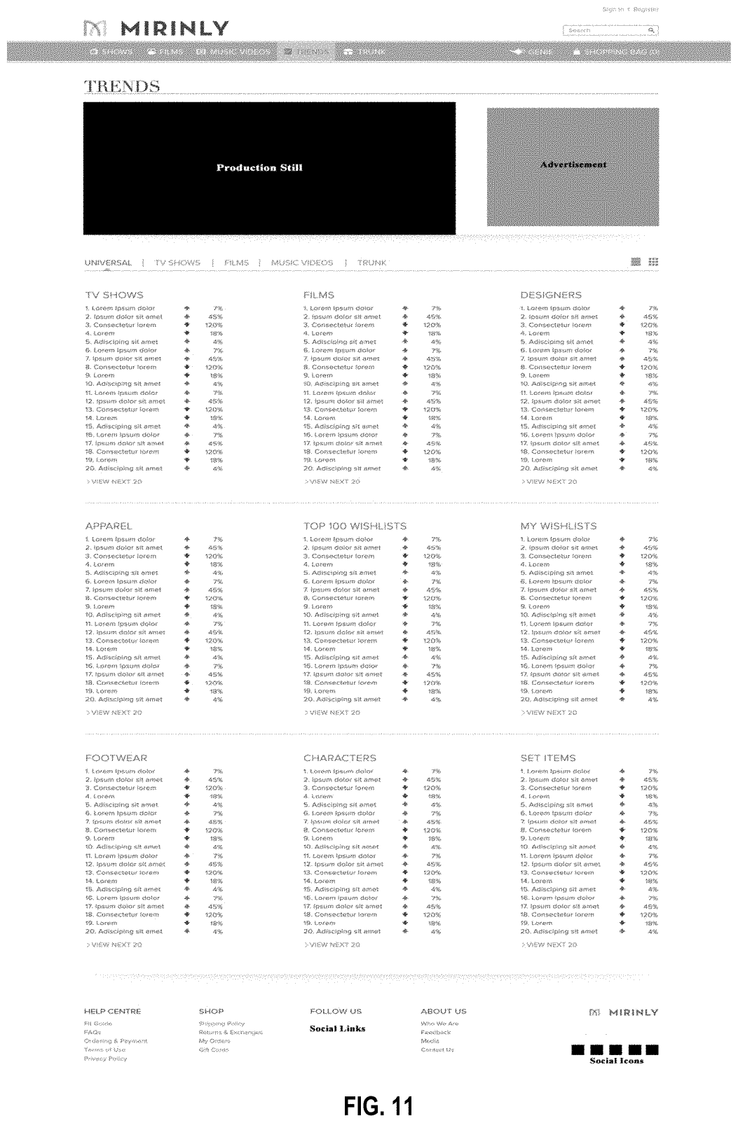

FIG. 11 is an example interface including trend information. The trends may be viewed as universal trends, such as show trends, film trends, music video trends, Trunk trends, or other activity or production content type. Once the trend scope is selected, such as universal in FIG. 11, the system identifies one or more trend categories. As shown in FIG. 11, nine trend categories are included. Within each trend category, the system then identifies one or more items trending. The identification may be based on the magnitude of trend (e.g., large up trend or large down trend). The identification may be based on the number of users indicating the item is of interest (e.g., favorite). The identification may be based on other system activity tracked by the programming promotion server 200. The interface shown in FIG. 11 includes a predetermined number of trending items. A control is provided that, upon activation, continues the listing of the items. In some implementations, the trending information may be updated dynamically such that as a user views a trending indicator, the trend value and/or icon may change. The dynamic updating of trends can also be implemented within other interfaces that also include trends.

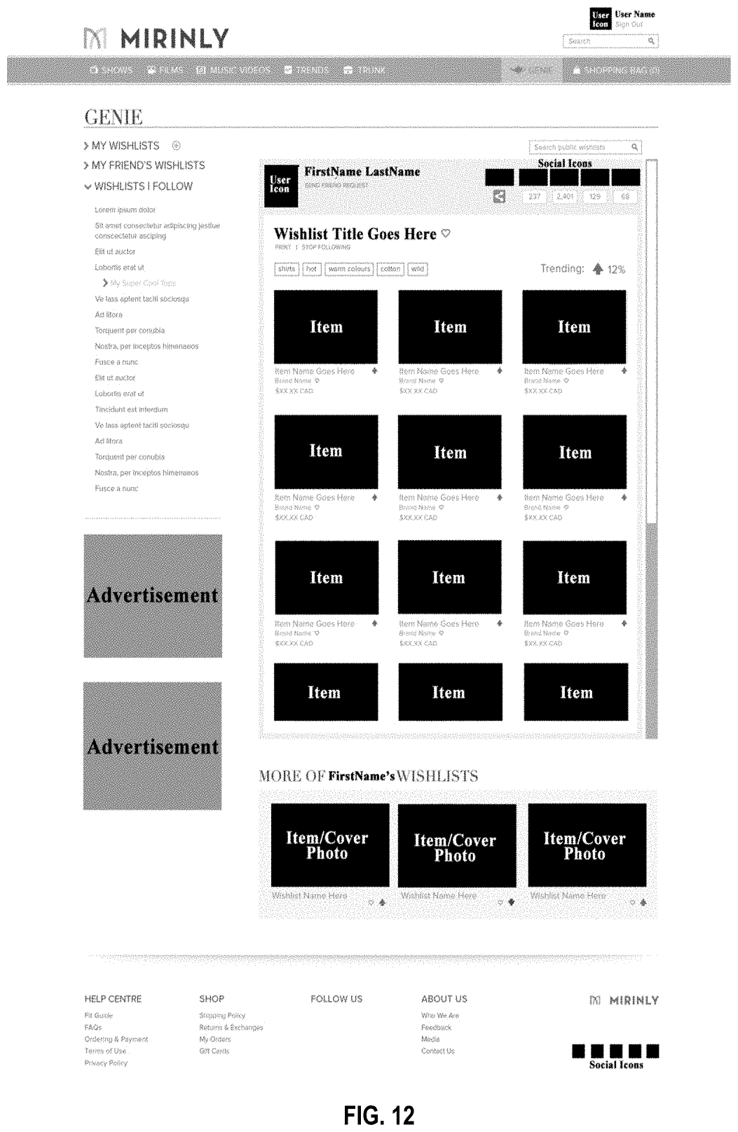

FIG. 12 is an example interface for wishlists. The interface includes one or more wishlists for the user, all of his friends' wishlists, and wishlists he is following. Users and partners (e.g., designers, retailers, programming content providers) can create a wishlist via the interface shown in FIG. 12, as well as share their wishlists within the system and other social networks. The interface includes an option to make the wishlist public, private, and private but only available to x amount of individuals by inviting certain users to the wishlist or only the user's friends. Users can follow public wishlists without friending the owner of one. Some interfaces include a list of all of the owner's public wishlists. With a word “tagging” system, the wishlist creator is able to select key words describing the content of his list (e.g. if the user is creating a summer outfit list, word tags could include words associated with summer), helping other users to search and find wishlists of interest quicker such as via a search control included in the interface. Wishlist owners have an option to allow others to contribute to the wishlist—these approved contributions would be acknowledged by for example, a color, associated with the contributor.

It will be appreciated that the interfaces shown in FIG. 5-12 include elements which may be easily included more than one interface. For example, wishlist elements in FIG. 12 may be included in the interface of FIG. 5.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers.

In some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

Certain aspects described may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the methods and apparatus described above without departing from the scope of the claims.

The terms “processor” and “processor unit,” as used herein are a broad terms, and are to be given their ordinary and customary meaning to a person of ordinary skill in the art (and are not to be limited to a special or customized meaning), and refer without limitation to a computer system, state machine, processor, or the like designed to perform arithmetic or logic operations using logic circuitry that responds to and processes the basic instructions that drive a computer. In some embodiments, the terms can include ROM and/or RAM associated therewith.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

As used herein, the term “message” encompasses a wide variety of formats for representing information for transmission. A message may include a machine readable aggregation of information such as an XML document, fixed field message, comma separated message, or the like. While recited in the singular, it will be understood that a message may be composed/transmitted/stored/received/etc. in multiple parts.

As used herein an interface (e.g., graphical user interface) may include a web-based interface including data fields for receiving input signals or providing electronic information. The interface may be implemented in whole or in part using technologies such as HTML, Flash, Java, .net, web services, and RSS. In some implementations, the interface may be included in a stand-alone client (for example, thick client, fat client) configured to communicate in accordance with one or more of the aspects described.

While the foregoing is directed to aspects of the present disclosure, other and further aspects of the disclosure may be devised without departing from the basic scope thereof, and the scope thereof is determined by the claims that follow.

What is claimed is:

1. A system for promoting items displayed in programming content, the system comprising:
a first interface to a programming content supplier system, the first interface configured to receive, from the programming content supplier system:
a selection of an item to be included in programming content; and
programming content information including a content identifier indicating where the item is displayed in the programming content;
a second interface to a promotion system, the second interface configured to receive, from the promotion system, item details for the item;
a promotion generator configured to associate an item identifier for the item with: (i) the content identifier of the programming content, and (ii) at least one of a character identifier for a character included in the programming content or a scene identifier for a scene included in the programming content;
an interface generator configured to:
receive an item request including the content identifier and at least one of the character identifier or the scene identifier;
generate an acquisition price for the item based at least in part on a unit price for the item identified in the item details and a commission or fee for the system; and
display the acquisition price and at least a portion of the item details received from the promotion system for the item, wherein the display includes an option to accept a promotion associated with the displayed items; and
a trend analyzer configured to:
receive the at least one of the character identifier or the scene identifier;
generate a set of graphical item trend indicators for items associated with the at least one of the character identifier or the scene identifier, each item trend indicator generated based on interactions of a plurality of users of the system with a respective item associated with a specific item trend indicator; and
generate a set of graphical content trend indicators for content associated with the at least one of the character identifier or the scene identifier, each content trend indicator generated based on interactions of the plurality of users of the system with respective content associated with a specific content trend indicator,
wherein the interface generator is further configured to:
obtain the set of item trend indicators and the set of content trend indicators from the trend analyzer based on the at least one of the character identifier or the scene identifier; and
display at least a portion of the set of graphical item trend indicators and at least a portion of the graphical content trend indicators concurrently with the respective items that are available for promotion.

2. The system of claim 1, wherein the interface generator comprises images of performers, on-screen personnel, animation characters or musicians from the programming content, and is configured to provide a link to items available for promotion that are used or worn by the performers, on-screen personnel, animation characters or musicians.

3. The system of claim 2, wherein the images of the performers, on-screen personnel, animation characters or musicians are displayed on a scrolling window of images.

4. The system of claim 1, wherein the interface generator comprises images of sets from the programming content, and is configured to provide a link to a good or a service shown in the set or on-screen for promotion.

5. The system of claim 1, wherein the data relating to an item available for promotion includes an item identifier, a retailer or service provider identifier, a character identifier, trend information for the item available for promotion, and item details.

6. The system of claim 5, wherein item details include one or more of: a size, a color, a dimension, a scent, a cut, a material, a fashion style, a grooming technique, scope of service and a location for an associated item.

7. The system of claim 1, wherein the programming content is one of an episode, a movie, a scene, a news program, informational programming, a music video, a commercial, a video game, a broadcast sporting event, live television programming, or a trailer.

8. The system of claim 1, wherein the option to accept the promotion associated with items comprises an aggregated option for accepting promotions associated with a plurality of items.

9. The system of claim 1, wherein the option to accept the promotion comprises an option to purchase the item.

10. The system of claim 9, wherein a programming content provider comprises one or more of a production studio, a broadcaster, or a content distributor.

11. The system of claim 1, wherein the interface generator is configured to pseudo-randomly display items including one or more elements of the retrieved programming content or production information in the view.

12. The system of claim 1, trend analyzer is configured to:
obtain a log of interactions of a plurality of users with the items available for promotion or content, the interactions conducted using the system, each interaction having an activity type;
assign a weight to each activity type; and
identify a trending indicator for the items available for promotion or the content based on a count of each activity type and the weight of each activity type.

13. The system of claim 12, wherein the log is obtained for items associated with the programming content, a performer, an episode, a scene, a set, a geographic location, apparel, makeup, accessories, or any combination thereof.

14. A system for promoting items displayed in programming content, the system comprising:
a first interface to a programming content supplier system, the first interface configured to receive, from the programming content supplier system:
a selection of an item to be included in programming content; and
programming content information including a content identifier indicating where the item is displayed in the programming content;
a second interface to a promotion system, the second interface configured to receive, from the promotion system, item details for the item;
a promotion generator configured to associate an item identifier for the item with: (i) the content identifier of the programming content, and (ii) at least one of a character identifier for a character included in the programming content or a scene identifier for a scene included in the programming content;
a trend analyzer configured to generate graphical trend indicators for items available for promotion and for content; and
an interface generator configured to:
receive the at least one of the character identifier or the scene identifier;
obtain a set of generated graphical item trend indicators for items that are: (i) associated with the at least one of the character identifier or the scene identifier, and (ii) available for promotion to a user;
obtain a set of generated graphical content trend indicators for content associated with the at least one of the character identifier or the scene identifier; and
display at least a portion of the set of item trend indicators and at least a portion of the content trend indicators.

15. The system of claim 14, wherein the interface generator is further configured to provide the user with an option to accept a promotion associated with the displayed items.

16. The system of claim 14, wherein the trend analyzer is configured to generate trend indicators by:
obtaining a log of interactions of a plurality of users with the items available for promotion or the content, the interactions conducted using the system, each interaction having an activity type;
assigning a weight to each activity type; and
identifying a trending indicator for the items available for promotion or the content based on a count of each activity type and the weight of each activity type.

17. The system of claim 16, wherein the activity type is one of: a social media publication, a user comment, a view, a favorite, an addition to a wish-list, a purchase, an order, or a share.

18. The system of claim 17, wherein the interface generator is further configured to display user comments and associated items based on the trend indicators.

19. The system of claim 17, wherein the wish-list comprises a set of items for promotion associated with an indicator of interest received from the user.

20. The system of claim 14, further comprising a personalization engine configured to receive, from the user, information identifying and updating a user's favorites, friend activity, and sponsored messages, and wherein the interface generator is configured to display trend information based on the received information.

21. The system of claim 14, wherein the interface generator comprises images of performers, on-screen personnel, animation characters, or musicians from the programming content, and is configured to provide a link to items available for promotion that are used or worn by the performers, on-screen personnel, animation characters, or musicians.

22. The system of claim 21, wherein the images of the performers, on-screen personnel, animation characters, or musicians are displayed on a scrolling window of images.

23. The system of claim 21, further comprising a personalization engine configured to receive, from the user, information identifying performer, on-screen person, animation character, or musician of interest, and wherein the interface generator is further configured to display trend information based on the performer, on-screen person, animation character, or musician of interest.

24. The system of claim 14, further comprising a personalization engine configured to receive, from the user, information identifying a set or on-screen image of interest, and wherein the interface generator is further configured to display trend information based on the set or on-screen image of interest.

25. The system of claim 14, wherein the interface generator is configured to pseudo-randomly display items including one or more elements of the retrieved programming content or production information in the view.

26. The system of claim 14, wherein the interface generator is further configured to:
receive an item request including the content identifier and at least one of the character identifier or the scene identifier;
generate an acquisition price for the item based at least in part on a unit price for the item identified in the item details and a commission or fee for the system; and
display the acquisition price and at least a portion of the item details received from the promotion system for the item, wherein the display includes an option to accept a promotion associated with the displayed items.
